(19) United States
(12) Patent Application Publication
(10) Pub. No.: US 2007/0205708 A1
(43) Pub. Date: Sep. 6, 2007

(54) IMAGE DISPLAY DEVICE

(76) Inventor: Tsuyoshi Oyaizu, Hiratsuka-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/679,396

(22) Filed: Feb. 27, 2007

Related U.S. Application Data
(63) Continuation of application No. PCT/JP05/15762, filed on Aug. 30, 2005.

(30) Foreign Application Priority Data
Aug. 31, 2004 (JP) 2004-252699

(51) Int. Cl. H01J 63/04; H01J 1/62

(52) U.S. Cl. 313/495; 313/496

(57) ABSTRACT

An image display device, including a front panel and a rear panel formed to be opposed to each other via a rectangular frame shaped side wall and a spacer, an inside of the device being maintained in high vacuum, wherein the rear panel has a plurality of electron discharge elements which discharge electrons, the front panel has an anode electrode and a ground electrode, the anode electrode being adapted to accelerate the electrons from the electron discharge elements, and an insulation layer consisting essentially of particulates whose particle diameter is in the range of 1 nm to 10 μm is formed between the anode electrode and the ground electrode.

### CROSS REFERENCE TO RELATED APPLICATIONS

This is a Continuation Application of PCT Application No. PCT/JP2005/015762, filed Aug. 30, 2005, which was published under PCT Article 21(2) in Japanese.

This application is based upon and claims the benefit of priority from prior Japanese Patent Application No. 2004-252699, filed Aug. 31, 2004, the entire contents of which are incorporated herein by reference.

### BACKGROUND OF THE INVENTION

1. Field of the Invention

The present invention relates to a flat type image display device that is a field emission display (FED), for example.

2. Description of the Related Art

In recent years, development of a flat type image display device has been progressed. In such an image display device, in order to restrict a discharge current in the case where an electric discharge has occurred between a front substrate and a rear substrate in a fluorescent screen structure, it is necessary to electrically break a metal back layer on the front substrate in a predetermined pattern.

In patent document 1 (Jpn. Pat. Appln. KOKAI Publication No. 2003-68237), an image display device and a method for manufacturing the device are disclosed. In this document, getter breaking is carried out in a particulate layer formed on a metal back layer in order to electrically separate a getter layer having electrical conductivity in plurality. That is, particulates whose particle diameter has been controlled are properly patterned in a film shape at a predetermined position on the metal back layer, thereby breaking the metal back layer or a getter film.

However, in the front panel suggested by a conventional technique, merely breaking the metal back layer or the like does not suffice. For example, an anode electrode supplied to the metal back layer and a ground electrode on the front panel must be sufficiently insulated from each other in order to restrict an occurrence of a creeping discharge to a side wall portion. Therefore, in order to save a creeping distance, there is provided a method for carrying out blast processing, for example, on a glass substrate surface between the anode electrode and the ground electrode.

However, this method needs high cost for carrying out blast processing and it is necessary to form an antistatic film between the anode electrode and the ground electrode after blast processing. Therefore, there is a problem that a process becomes complicated.

### BRIEF SUMMARY OF THE INVENTION

It is an object of the present invention to provide an image display device that achieves a high creeping withstand voltage by insulating an anode electrode and a ground electrode on a front panel from each other in accordance with a simple method.

The present invention provides an image display device comprising a front panel and a rear panel formed to be opposed to each other via a rectangular frame shaped side wall and a spacer, an inside of the device being maintained in high vacuum, wherein the rear panel has a plurality of electron discharge elements which discharge electrons, the front panel has an anode electrode and a ground electrode, the anode electrode being adapted to accelerate the electrons from the electron discharge elements, and an insulation layer consisting essentially of particulates whose particle diameter is in the range of 1 nm to 10 μm is formed between the anode electrode and the ground electrode.

In addition, the present invention also provides a image display device comprising a front panel and a rear panel formed to be opposed to each other via a spacer, wherein the rear panel has a plurality of electron discharge elements which discharge electrons, and the front panel has: a plurality of phosphor layers formed on a glass substrate; a plurality of light absorption layers provided between said plurality of phosphor layers, respectively; a metal back layer formed on said plurality of phosphor layers and electrically broken in plurality; an anode electrode connected to the metal back layer and adapted to accelerate the electrons from the electron discharge elements; a ground electrode; and an insulation layer consisting essentially of particulates whose particle diameter is in the range of 1 nm to 10 μm and formed between the anode electrode and the ground electrode.

In this manner, the image display device according to the present invention can achieve a high creeping withstand voltage and restrict an occurrence of a creeping discharge by forming a particulate insulation layer whose particle diameter is 1 nm to 10 μm, without carrying out blast processing, when carrying out insulation between the anode electrode and the ground electrode for supplying an anode of the metal back layer or the like on the front panel.

### BRIEF DESCRIPTION OF THE SEVERAL VIEWS OF THE DRAWING

FIG. 1 is a perspective view showing an FED according to an embodiment of the present invention.

FIG. 2 is a sectional view taken along the line A-A of FIG. 1, of the FED according to an embodiment of the present invention.

FIG. 3 is a detailed sectional view showing an example of the FED according to an embodiment of the present invention.

FIG. 4 is view illustrating an example of a creeping withstand voltage of the FED according to an embodiment of the present invention.

### DETAILED DESCRIPTION OF THE INVENTION

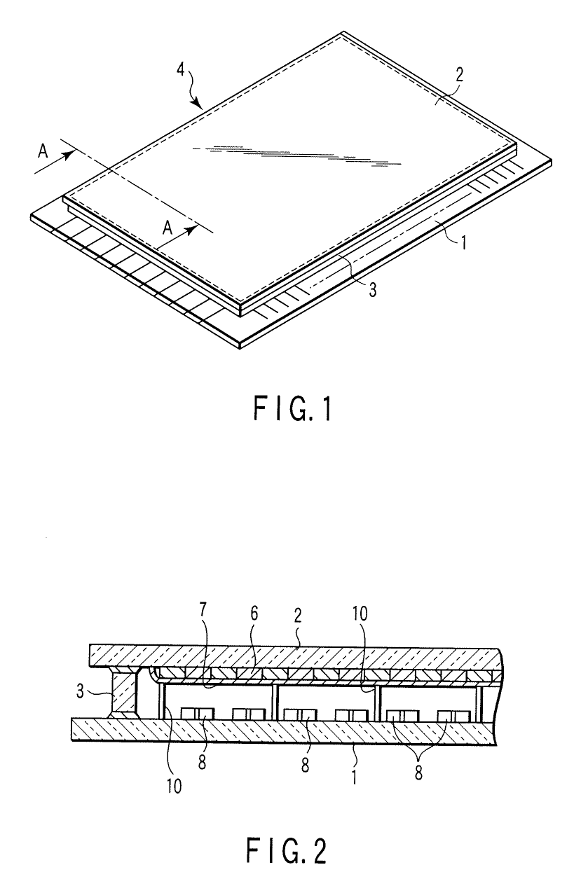

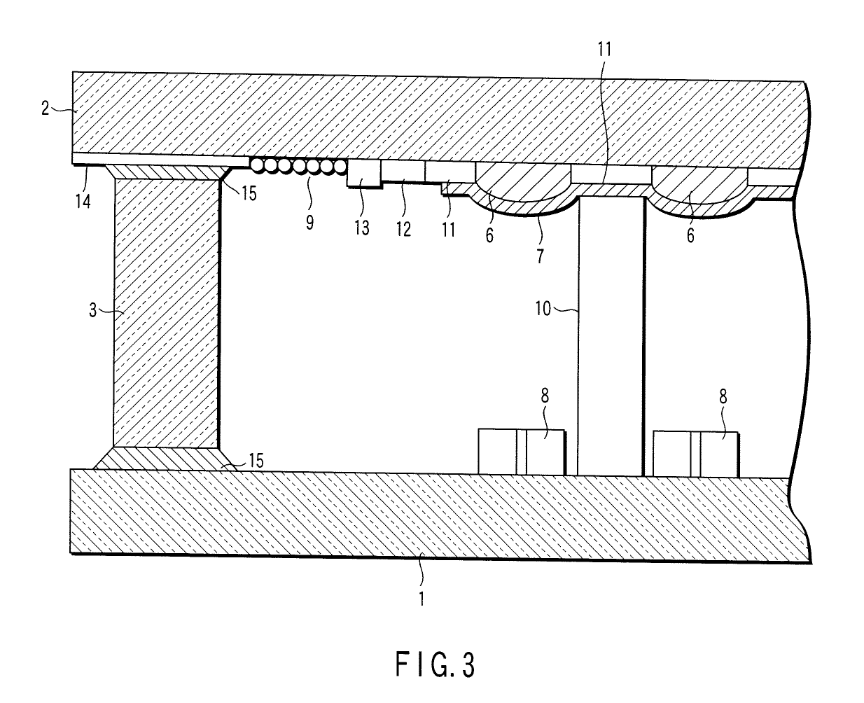

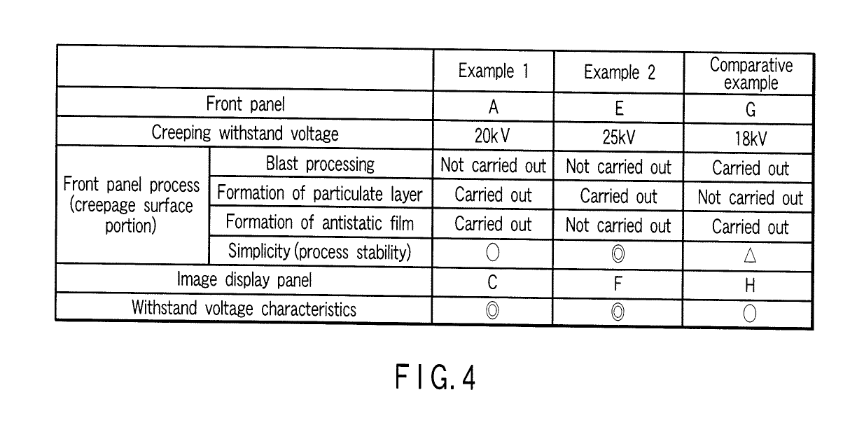

Hereinafter, an embodiment of a display device according to the present invention will be described in detail with reference to the accompanying drawings. FIG. 1 is a perspective view showing an FED according to an embodiment of the present invention. FIG. 2 is a sectional view taken along the line A-A of FIG. 1, of the FED according to an embodiment of the present invention. FIG. 3 is a detailed sectional view showing an example of the FED according to an embodiment of the present invention. FIG. 4 is view illustrating an example of a creeping withstand voltage of the FED according to an embodiment of the present invention.

The FED according to an embodiment of the present invention comprises a front panel 2 and a rear panel 1 each made of a rectangular glass, as shown in FIGS. 1 and 2. These panels are allocated to be opposed to each other with a gap of 1 to 2 mm therebetween. The front panel 2 and the rear panel 1 are joined with each other at their peripheral rims via a rectangular frame shaped side wall portion 3. These panels each configure a flat, rectangular vacuum envelope 4 maintained in high vacuum of about 10⁻⁴ Pa or less at the inside thereof.

A fluorescent screen is formed on an internal face of the front panel 2. This fluorescent screen is composed of a phosphor layer 6 that emits red, green, and blue lights and a matrix shaped light shielding layer 11, as described later. A metal back layer 7 that functions as an anode electrode is formed on the fluorescent screen. At the time of a display operation, a predetermined anode voltage is applied to the metal back layer 7.

In addition, a number of electron discharge elements 8 that discharge electron beams for exciting the phosphor layer 6 are provided on an internal face of the rear panel 1. These electron discharge elements 8 are arranged in a plurality of columns and in a plurality of lines in association with pixels. The electron discharge elements are driven by means of matrix wiring, although not shown.

In addition, a number of spacers 10 formed in a planar shape or in a columnar shape are allocated between the rear panel 1 and the front panel 2 for the purpose of withstanding an atmospheric pressure.

An anode voltage is applied to the fluorescent screen via the metal back layer 7, and the electron beams discharged from the electron discharge elements 8 are accelerated by the applied anode voltage, and then, the accelerated electron beams collide with the fluorescent screen. In this manner, the corresponding phosphor layer 6 emits light, and a video image is displayed.

(Detailed Structure and Particulate Layer)

With reference to FIG. 3, a description will be given below with respect to an example of a detailed configuration of a screen display device according to an embodiment of the present invention. That is, in the screen display device according to an embodiment of the present invention, in FIG. 3, in addition to the phosphor layer 6 and the light shielding layer 11, the metal back layer 7 and the spacer 10 or the electron discharge elements 8 of the rear panel 1, a resistor layer 12 and an anode electrode 13 are provided at the side of the front panel 2, the resistor layer 12 being provided adjacent to the light shielding layer 11.

Further, the side wall portion 3 is connected to the front panel 2 and the rear panel 1 via indium 15 that is a binder. In particular, on the front panel 2, as shown in FIG. 3, a ground electrode 14 is provided between the indium 15 and the front panel 2.

In such a configuration, the anode electrode 13 and the ground electrode 14 must be electrically insulated from each other. One of such methods is to carry out blast processing with respect to a glass substrate that is the front panel 2.

In another method, in an embodiment according to the present invention, a creeping distance can be increased, as is the case with blast processing, by forming a particulate resistor layer 9 between the anode electrode 13 and the ground electrode 14. The particle diameter of the particulate is required to be in the range of 1 nm to 10 μm. If the particle diameter is 1 nm or less, the surface roughness of the formed particulate resistor layer 9 becomes insufficient, and thus, a target creeping distance cannot be increased. In contrast, if the particle diameter is 10 μm or more, the formation of the particulate resistor layer 9 is extremely deteriorated, and a resolution degradation due to film releasing or the like becomes unavoidable. In addition, the film thickness of the particulate resistor layer 9 must be 30 μm or less. If the film thickness is 30 μm or more, the film strength is lowered, and there occurs degradation of resolution due to film releasing or the like, or degradation of withstand voltage characteristics due to the resistor layer itself becoming an electric discharge source.

SiO₂, Al₂O₃, TiO₂, PbO and the like can be used as the particulates. The particulates are not limited thereto, however, as long as they are excellent in heat resistance and the particle diameter is controlled. In addition, as a method for forming the particulate resistor layer 9, there can be used a screen print technique or a photolithography technique using a photoresist. In the case where the particulate resistor layer 9 is formed in accordance with the screen print technique, the layer can be obtained by using a screen plate to pattern: the particulates serving as fillers; a resin for adjusting viscosity; and further, a paste kneaded using a solvent to a predetermined position. Further, a glass flit is introduced into the paste described previously, thereby making it possible to further improve film strength and to form a stable particulate resistor layer 9.

A resisting agent is introduced into the particulate resistor layer 9, thereby making it possible to attain an antistatic effect. The resistance value of this resisting agent must be in the range of 1E4 Ω/□ (Ω/square) to 1E1 Ω/□. The resistance value is too low if it is 1E4 Ω/□ or less, in which case the anode electrode 13 and the ground electrode 14 are electrically connected to each other, thus making it impossible to attain the antistatic effect. In addition, the resistance value is too high if it is 1E14 Ω/□ or more, making it impossible to attain the antistatic effect. ATO, ITO, PTO and the like can be used as a resisting agent without being limited thereto.

### EXAMPLE 1

Now, the present invention will be described in further detail by way of examples.

A panel comprising a phosphor layer 6 and a metal back layer 7 was prepared at a predetermined position on a glass substrate; an anode electrode 13 was connected to the fluorescent screen metal back layer 7; a ground electrode 14 was installed at the periphery thereof; and a particulate resistor layer 9 was formed between the anode electrode 13 and the ground electrode 14 using a composition B paste in accordance with the screen print technique. Then, an antistatic film was formed on the particulate resistor layer 9 and this panel was fired at 450° C., whereby an organic component was burned out, and a front panel A was obtained.

| | | |
|---|---|---|
| Composition B | SiO₂ | 15 wt % |
| | Glass flit | 20 wt % |
| | Ethyl cellulose | 6 wt % |
| | Butyl carbitol acetate | 59 wt % |

Then, this front panel was bonded with a rear panel 1 having electron discharge elements 8 via spacers 10; the inside was maintained in high vacuum; the anode electrode 13 was connected to a high voltage supply portion; and the ground electrode 14 was connected to a ground, whereby an image display panel C was obtained.

### EXAMPLE 2

Further, using a composition D paste instead of the composition B paste of Example 1, an antistatic particulate resistor layer 9 was formed, which was then fired at 450° C., whereby a front panel E was obtained. An image display panel F was obtained in accordance with a process similar to that of Example 1.

### COMPARATIVE EXAMPLE

Blast processing was carried out between an anode electrode 13 and a ground electrode 14 instead of the composition B paste printing of Example 1. Then, an antistatic film was formed on a processing face, and the formed film was fired at 450° C., whereby a front panel G was obtained. An image display panel H was obtained by a process similar to that of Example 1.

FIG. 4 is an illustrative view showing: results obtained by measuring creeping withstand voltages of these three front panels A, E, and G, respectively; withstand voltage characteristics of the image display panels C, F, and H; and simplicity of each process. According to this illustrative view, in Example 1, a creeping withstand voltage was obtained as 20 kV, and in Example 2, a creeping withstand voltage was obtained as 25 kV. In both cases, the creeping withstand voltage in the case where blast processing was carried out was obtained as a value exceeding 18 kV. Further, the process simplicity of Examples 1 and 2 also exceeds that of a case in which blast processing has been carried out.

Therefore, according to the embodiment of the present invention, it is found possible to provide an image display device having a creepage surface structure with excellent creeping withstand voltage, process stability, and withstand voltage characteristics, by forming the particulate resistor layer 9 between the anode electrode 13 and the ground electrode 14.

One skilled in the art can achieve the present invention in accordance with a variety of the embodiments described above. Further, a variety of modified examples of these embodiments can be easily conceived by one skilled in the art, making it possible to apply the present invention to a variety of embodiments even if one does not have any inventive ability. Therefore, the present invention covers a broad range without departing from a disclosed principle and novel features, and is not limited to the embodiments described above.

What is claimed is:

1. An image display device comprising a front panel and a rear panel formed to be opposed to each other via a rectangular frame shaped side wall and a spacer, an inside of the device being maintained in high vacuum,
wherein the rear panel has a plurality of electron discharge elements which discharge electrons,
the front panel has an anode electrode and a ground electrode, the anode electrode being adapted to accelerate the electrons from the electron discharge elements, and
an insulation layer consisting essentially of particulates whose particle diameter is in the range of 1 nm to 10 μm is formed between the anode electrode and the ground electrode.

2. The image display device according to claim 1, wherein a film thickness of the insulation layer is 30 μm or less.

3. The image display device according to claim 1, wherein a resistance value of the particulates of the insulation layer is in the range of 1E4 Ω/□ to 1E14 Ω/□.

4. An image display device comprising a front panel and a rear panel formed to be opposed to each other via a spacer,
wherein the rear panel has a plurality of electron discharge elements which discharge electrons, and
the front panel has:
a plurality of phosphor layers formed on a glass substrate;
a plurality of light absorption layers provided between said plurality of phosphor layers, respectively;
a metal back layer formed on said plurality of phosphor layers and electrically broken in plurality;
an anode electrode connected to the metal back layer and adapted to accelerate the electrons from the electron discharge elements;
a ground electrode; and
an insulation layer consisting essentially of particulates whose particle diameter is in the range of 1 nm to 10 μm and formed between the anode electrode and the ground electrode.

5. The image display device according to claim 4, wherein a film thickness of the insulation layer is 30 μm or less.

6. The image display device according to claim 4, wherein a resistance value of the particulates of the insulation layer is in the range of 1E4 Ω/□ to 1E14 Ω/□.
